(19) United States
(12) Patent Application Publication
(10) Pub. No.: US 2015/0022751 A1
(43) Pub. Date: Jan. 22, 2015

(54) Driving Method of Arranging Turn-on Order of Gate Lines for Liquid Crystal Display Device and Related Device

(71) Applicant: AU Optronics Corp., Hsin-Chu (TW)

(72) Inventor: Chia-Tsung Chaing, Hsin-Chu (TW)

(21) Appl. No.: 14/507,808

(22) Filed: Oct. 6, 2014

Related U.S. Application Data
(62) Division of application No. 13/092,964, filed on Apr. 24, 2011.

(30) Foreign Application Priority Data
Dec. 28, 2010 (TW) 099146236

(51) Int. Cl. G02F 1/133

(52) U.S. Cl. CPC G02F 1/13306
USPC 349/43

(57) ABSTRACT

A driving method for a liquid crystal display (LCD) device is disclosed. The LCD device includes a plurality of data lines and a plurality of thin film transistors (TFTs). The driving method includes restoring data of a plurality of sub-pixels of a first frame, wherein the sub-pixels corresponds to the plurality of TFTs; arranging a turn-on order of the plurality of TFTs on each of a plurality of data lines according to the data of the plurality of sub-pixels; and turning on the plurality of TFTs on each of the plurality of data lines according to the turn-on order.

### CROSS REFERENCE TO RELATED APPLICATIONS

This application is a divisional application of U.S. application Ser. No. 13/092,964, filed on Apr. 24, 2011, and entitled “Driving Method of Arranging a Turn-on Order of Gate Lines for Liquid Crystal Display Device and Related Device” the contents of which are incorporated herein.

### BACKGROUND OF THE INVENTION

1. Field of the Invention

The present invention relates to a driving method for a liquid crystal display (LCD) device and related device, and more particularly, to a driving method for a LCD device and related device, capable of arranging a turn-on order of a plurality of gate lines.

2. Description of the Prior Art

The advantages of a liquid crystal display (LCD) include lighter weight, less electrical consumption, and less radiation contamination as compared to other conventional displays. Thus, LCD devices have been widely applied to various portable information products, such as notebooks, PDAs, etc. In an LCD device, incident light produces different polarization or refraction effects when the alignment of liquid crystal molecules is altered. The transmission of the incident light is affected by the liquid crystal molecules, and thus magnitude of the light emitting out of the liquid crystal molecules varies. The LCD device utilizes the characteristics of the liquid crystal molecules to control the corresponding light transmittance and produces gorgeous images according to different magnitudes of red, blue, and green light.

Please refer to FIG. 1, which illustrates a schematic diagram of a prior art thin film transistor (TFT) LCD device 10. The LCD device 10 includes an LCD panel 100, a timing controller 102, a source driver 104, and a gate driver 106. The LCD panel 100 is constructed by two parallel substrates, and the liquid crystal molecules are filled up between these two substrates. A plurality of data lines D1˜Dm, a plurality of gate lines G1˜Gn that are perpendicular to the data lines D1˜Dm, and a plurality of TFTs 114 are positioned on one of the substrates. There is a common electrode installed on another substrate for outputting a common voltage Vcom via the common electrode. Please note that only four of the TFTs 114 are shown in FIG. 1 for simplicity. In actuality, each intersection of the data lines D1˜Dm and gate lines G1˜Gn of the LCD panel 100 has one TFT 114 installed. In other words, the TFTs 114 are arranged in a matrix on the LCD panel 100. The data lines D1˜Dm correspond to different columns, and the gate lines G1˜Gn correspond to different rows. The LCD device 10 uses a column and a row to locate an associated TFT 114 which corresponds to a specific pixel. In addition, the two parallel substrates of the LCD panel 100 filled up with liquid crystal molecules can be considered as an equivalent capacitor 116.

The operation of the prior art LCD device 10 is detailed as follows. First, the timing controller 102 generates corresponding control signals and timing signals according to image data being displayed. The source driver 104 and the gate driver 106 then respectively generate driving signals and gate signals to corresponding data lines 110 and gate lines 112 gate line according to the signals sent by the timing controller 102 for turning on the corresponding TFTs 114 and keeping a voltage difference of the equivalent capacitors 116, to change the alignment of liquid crystal molecules and light transmittance, so that the image data can be displayed in the display panel 100. For example, the gate driver 106 outputs a pulse to the gate line G1˜Gn for turning on the TFT 114. Therefore, the driving signals generated by the source driver 104 are inputted into the equivalent capacitor 116 through the data line 110 and the TFT 114. The voltage difference kept by the equivalent capacitor 116 can then adjust a corresponding gray level of the related pixel through affecting the related alignment of liquid crystal molecules positioned between the two parallel substrates. In addition, the source driver 104 generates the input signals, and magnitude of each input signal inputted to the data lines D1˜Dm corresponds to different gray levels.

If the LCD device 10 continuously uses a positive voltage to drive the liquid crystal molecules, the liquid crystal molecules will not quickly change a corresponding alignment according to the applied voltages because of accumulated residual charges. Similarly, if the LCD device 10 continuously uses a negative voltage to drive the liquid crystal molecules, the liquid crystal molecules will not quickly change a corresponding alignment according to the applied voltages. Thus, the incident light will not produce accurate polarization or refraction, and the quality of images displayed on the LCD device 10 deteriorates. In order to protect the liquid crystal molecules from being irregular, the LCD device 10 must alternately use positive and negative voltages to drive the liquid crystal molecules. In addition, not only does the LCD panel 100 have the equivalent capacitors 116, but the related circuit will also have some parasitic capacitors owing to its intrinsic structure. When the same image is displayed on the LCD panel 100 for a long time, the parasite capacitors will be charged to generate a residual image effect. The residual image with regard to the parasitic capacitors will further distort the following images displayed on the same LCD panel 100. Therefore, the LCD device 10 must alternately use the positive and the negative voltages to drive the liquid crystal molecules for eliminating the undesired residual image effect.

Please refer to FIG. 2, which is a schematic diagram of a table 80 in the prior art. The table 80 illustrates a turn-on order of gate lines G1˜G10, and polarities of sub-pixels on the data lines D1 and D2. In the table 80, the turn-on order of the gate lines G1˜G10 is G1, G2, G3, . . . , G10. Since the driving method used herein is two-line-dot inversion, driving voltages of the sub-pixels on data line D1 are V14, V14, V2, V2, V12, V12, V4, V4, V10, V10. The driving voltages V14, V12, V10, V4, V2 correspond to different grayscales. Please refer to FIG. 3, which is a voltage waveform of the data line D1 in FIG. 2. As derived from FIG. 3, since the turn-on order of the gate lines is G1, G2, G3, . . . , G10, a source driver has to output different voltages to generate different grayscales. However, such a driving method causes unnecessary power loss, and compromises system performance.

### SUMMARY OF THE INVENTION

The present disclosure discloses a driving method for a LCD device having a plurality of data lines and a plurality of thin film transistors (TFTs). The driving method comprises restoring data of a plurality of sub-pixels of a first frame, wherein the sub-pixels corresponds to the plurality of TFTs; arranging a turn-on order of the plurality of TFTs on each of a plurality of data lines according to the data of the plurality of sub-pixels; and turning on the plurality of TFTs on each of the plurality of data lines according to the turn-on order.

The present disclosure further discloses a LCD device, comprising a panel having a plurality of data lines and a plurality of TFTs, wherein the plurality of TFTs corresponds to a plurality of sub-pixels of a first frame; a backlight module, for providing backlights to the panel; and a timing control device comprising a frame buffer, for restoring data of the plurality of sub-pixels of the first frame; a calculation unit, for arranging a turn-on order of the plurality of TFTs on each of the plurality of data lines according to the data of the plurality of sub-pixels; and a gate driver, for turning on the plurality of TFTs on each of the plurality of data lines according to the turn-on order.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art thin film transistor liquid crystal display (LCD) device.

FIG. 2 is a schematic diagram of a prior art table.

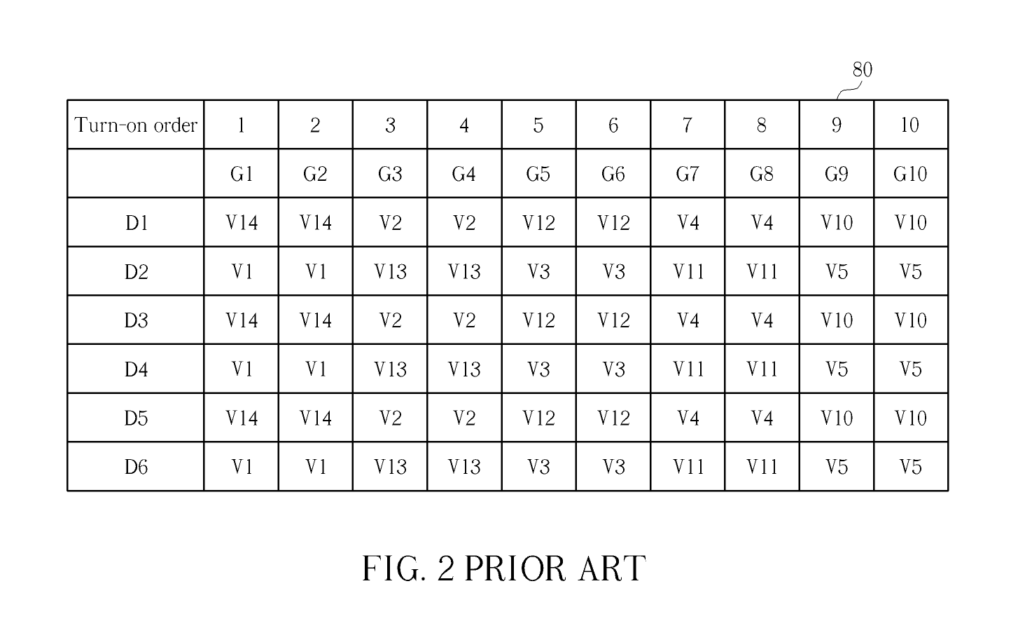

FIG. 3 is a voltage waveform of a data line in FIG. 2.

FIG. 4 is a schematic diagram of a LCD device according to an embodiment of the present invention driving method.

FIG. 5 is a schematic diagram of a table according to an embodiment of the present invention.

FIG. 6 is a voltage waveform of a data line in FIG. 5.

FIG. 7 is a schematic diagram of a table according to an embodiment of the present invention.

FIG. 8 is a voltage waveform of a data line in FIG. 7.

FIG. 9 is a schematic diagram of a first frame and a second frame according to an embodiment of the present invention.

FIG. 10 is a schematic diagram of a process according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

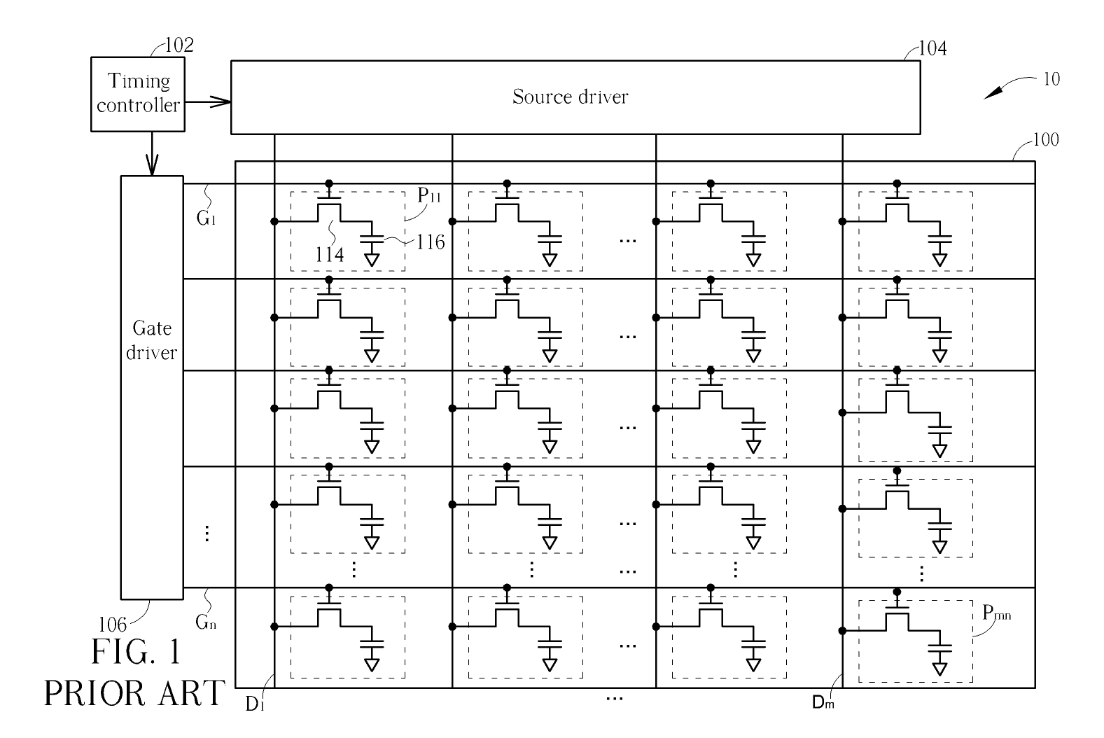

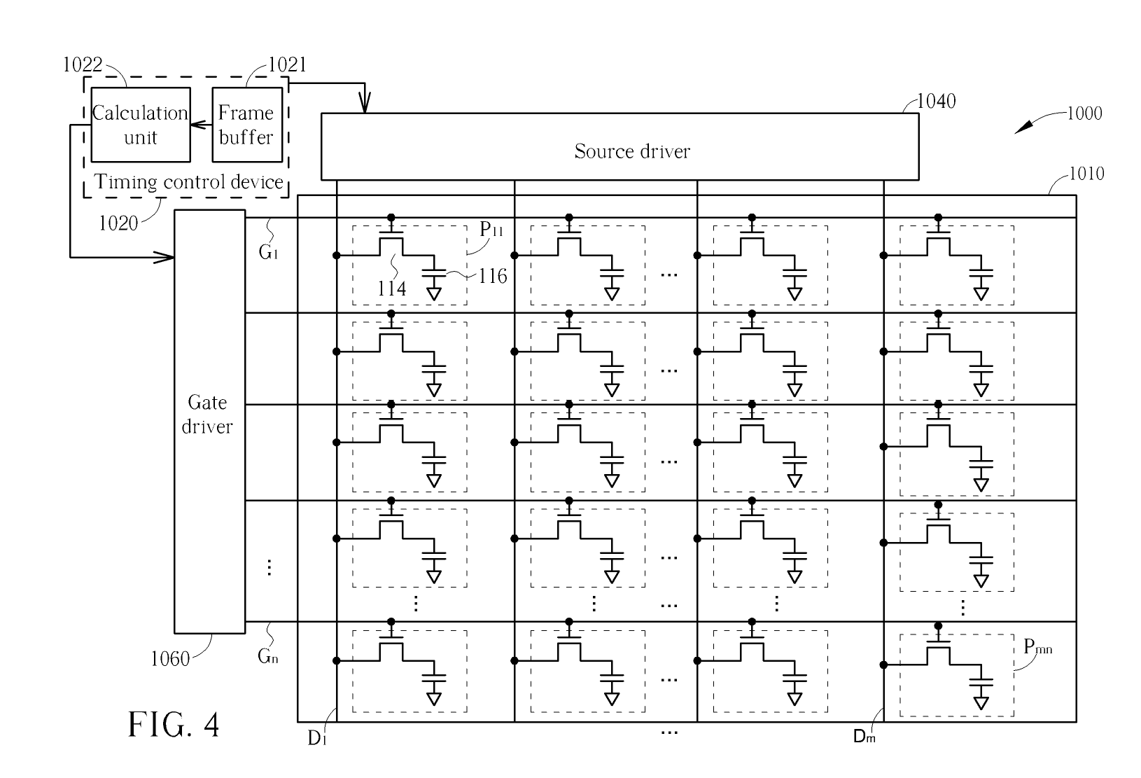

Please refer to FIG. 4, which is a schematic diagram of a liquid crystal display (LCD) device 1000 according to an embodiment of the present invention. The LCD device 1000 may use a row inversion driving method, a two-line-dot inversion driving method or other inversion driving methods. The LCD device 1000 includes an LCD panel 1010, a timing control device 1020, a source driver 1040, a gate driver 1060, a plurality of data lines D1˜Dm, a plurality of gate lines G1˜Gn and a plurality of the sub-pixels P11˜Pmn. The data lines D1˜Dm and the gate lines G1˜Gn are intersected, and the sub-pixels P11˜Pmn are positioned on each intersections of the data lines D1˜Dm and the gate lines G1˜Gn. The sub-pixels P11˜Pmn correspond to a plurality of thin film transistors (TFTs) T11˜Tmn. A structure of the LCD device 1000 is similar to the TFT LCD device 10 in FIG. 1, and thus similarities are not narrated herein. As for the differences, the timing control device 1020 includes a frame buffer 1021 and a calculation unit 1022. The gate driver 1060 includes a multiplexer. The frame buffer 1021 is coupled to the LCD panel 1010 and used for restoring data of the sub-pixels P11˜Pmn of a frame F1. The calculation unit 1022 is coupled to the frame buffer 1021 and used for arranging a turn-on order of the TFTs, e.g. T11˜Tln, on each of the data lines D1˜Dm, e.g. data line D1, according to data of the sub-pixels P11˜Pmn. Namely, when the frame buffer 1021 receives the data of the sub-pixels P11˜Pmn of the frame F1 from the LCD panel 1010, the calculation unit 1022 arranges the turn-on order of the gate lines G1˜Gn, and orderly turns on the TFTs, e.g. T11˜Tln, on each of the data lines D1˜Dm, e.g. data line D1, according to the data of the sub-pixels P11˜Pmn. According to the example of the present invention, the frame buffer 1021 receives the data of all sub-pixels of the frame F1 and then the calculation unit 1022 arranges the turn-on order of the gate lines G1˜Gn, however, the present invention is not limited hereinafter. The frame buffer 1021 may cache data of ¼ frame, or data of multiple frames. Note that, when the frame F1 changes to a frame F2, the frame buffer 1021 clears the data of the sub-pixels P11˜Pmn of the frame F1, and caches data of sub-pixels P11˜Pmn of the frame F2. In addition, the gate driver 1060 may include the multiplexer (not shown in FIG. 4). Preferably, the turn-on order of the TFTs T11˜Tmn on each of the data lines D1˜Dm, i.e. the turn-on order of the gate lines G1˜Gn, can be represented by a binary code, and transmitted to the multiplexer of the gate driver 1060, thereby driving the gate lines G1˜Gn according to the binary code.

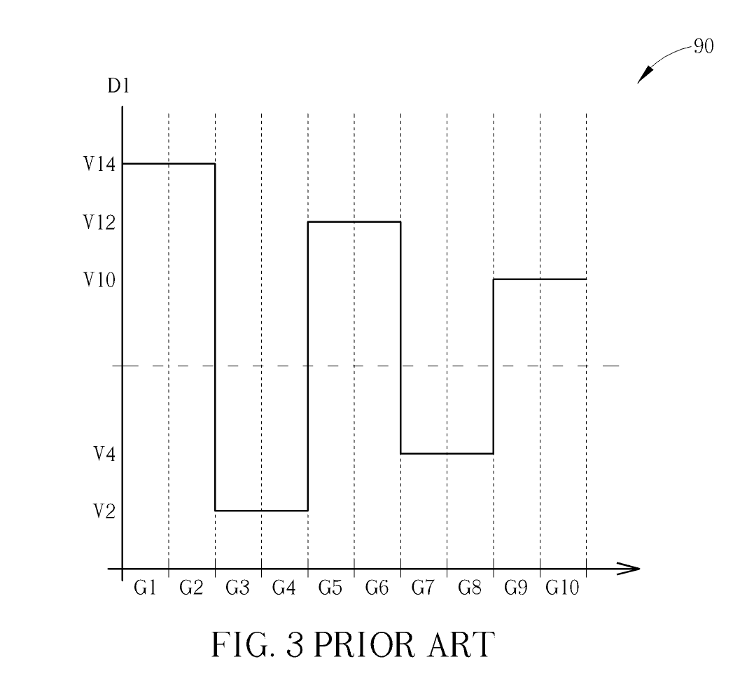

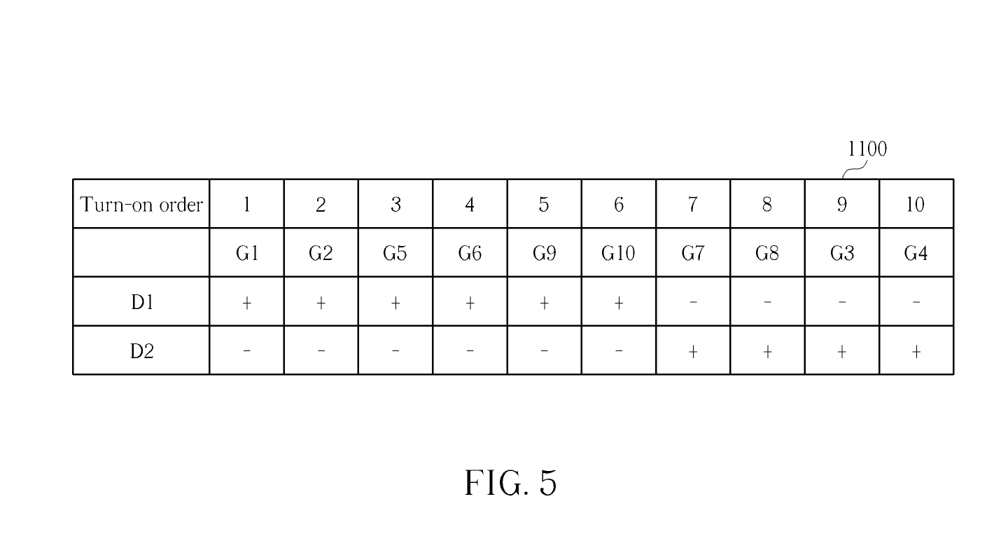

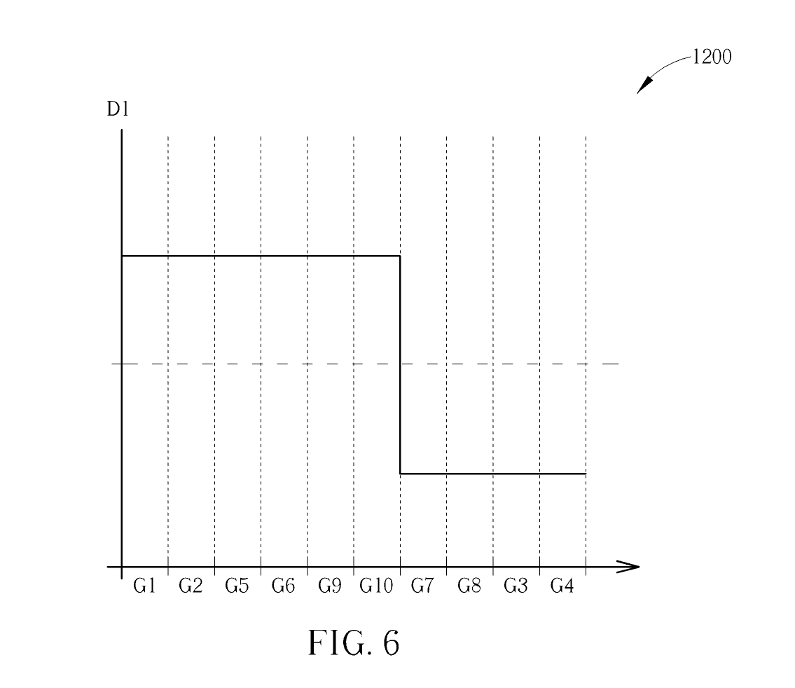

Preferably, the data of the sub-pixels P11˜Pmn may be polarities of the sub-pixels or driving voltages of the sub-pixels. When the data of the sub-pixels P11˜Pmn are the polarities of the sub-pixels, the calculation unit 1022 arranges the turn-on order of the TFTs, e.g. T11˜Tln, on each of data lines, e.g. the data line D1, such that corresponding sub-pixels of two TFTs conducted consecutively in time on have the same polarity. In short, the calculation unit 1022 arranges the turn-on order of the gate lines G1˜Gn according to the polarities of the sub-pixels, such that the corresponding sub-pixels of the two TFTs conducted consecutively in time have the same polarity. Consequently, the source driver 1040 reduces the frequency of outputting positive and negative voltages alternately, and thus achieves power conservation. Please refer to FIG. 5, which is a schematic diagram of a table 1100 according to an example of the present invention. The table 1100 illustrates a turn-on order of gate lines G1˜G10 and polarities of sub-pixels on data lines D1 and D2. In the table 1100, the turn-on order of the gate lines G1˜G10 is G1, G2, G5, G6, G9, G10, G7, G8, G3, G4, thus polarities of sub-pixels on a data line D1 are arranged orderly +, +, +, +, +, +, −, −, −, − and polarities of sub-pixels on a data lines D2 are arranged orderly −, −, −, −, −, −, +, +, +, +. Please refer to FIG. 6, which is a voltage waveform 1200 of the data lines D1 in FIG. 5. Comparing to alternately aligned positive-polarity sub-pixels and negative-polarity sub-pixels in the table 60, positive-polarity sub-pixels are aligned side-by-side, and negative-polarity sub-pixels are aligned side-by-side in the table 1100. As seen in FIG. 6, since the turn-on order of the gate lines G1˜G10 is G1, G2, G5, G6, G9, G10, G7, G8, G3, G4, the source driver 1040 outputs positive voltages to drive the positive-polarity sub-pixels first, and then outputs negative voltages to drive the negative-polarity sub-pixels. Comparing to FIG. 3 according to the prior art, the example of the present invention only has one alternation from positive voltage to negative voltage, and thus reduces power consumption.

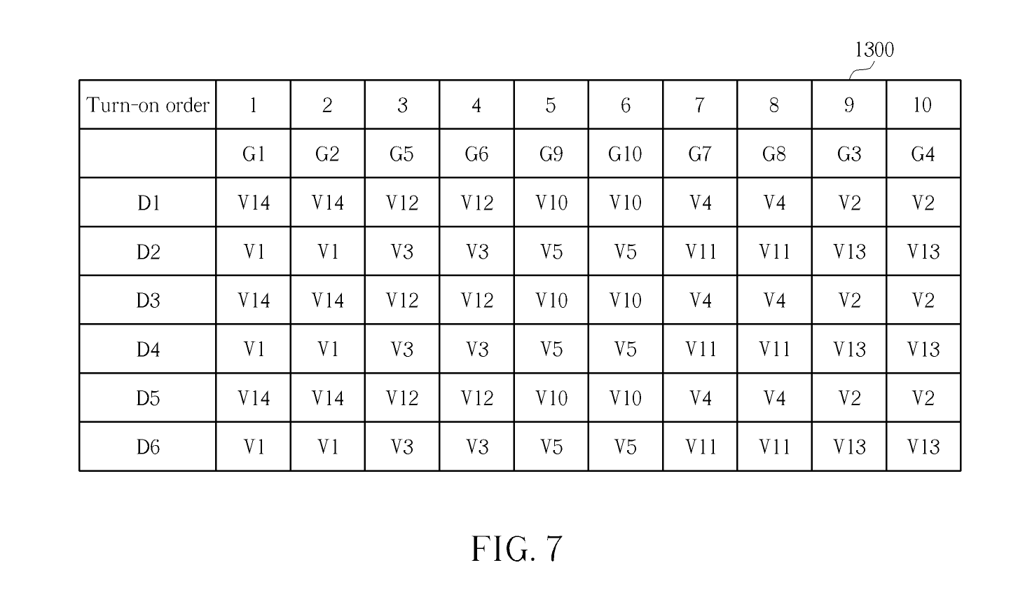

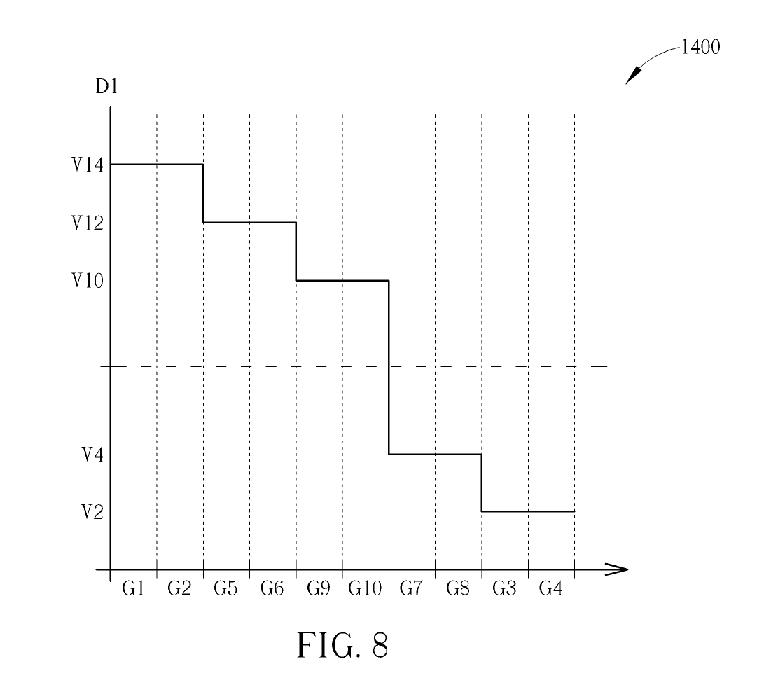

When the data of the sub-pixels P11˜Pmn are driving voltages of the sub-pixels, the calculation unit 1022 arranges the turn-on order of the TFTs, e.g. T11˜Tln, on each of data lines, e.g. the data line D1, such that corresponding sub-pixels of two TFTs conducted consecutively in time have a minimum driving voltage difference. In short, the calculation unit 1022 arranges the turn-on order of the gate lines G1˜Gn according to the driving voltages of the sub-pixels, such that the corresponding sub-pixels of the two TFTs conducted consecutively in time have the minimum driving voltage difference. Consequently, the source driver 1040 reduces the frequency of outputting positive and negative voltages alternately or avoids adjacently outputted driving voltages varying too greatly, and thus achieves power conservation. Please refer to FIG. 7, which is a schematic diagram of a table 1300 according to an example of the present invention. The table 1300 illustrates a turn-on order of gate lines G1˜G10 and driving voltages of sub-pixels on data lines D1 and D2. In the table 1300, the turn-on order of the gate lines G1˜G10 is G1, G2, G5, G6, G9, G10, G7, G8, G3, G4, and thus driving voltages of sub-pixels on a data line D1 are V14, V14, V12, V12, V10, V10, V4, V4, V2, V2, respectively. The driving voltages V14, V12, V10, V4, V2 correspond to different grayscales. Comparing to the table 80, the example of the present invention turns on gate line G2, prior to turning on gate line G5, which reduces a voltage difference of adjacently outputted driving voltages. Please refer to FIG. 8, which is a voltage waveform 1400 of the data line D1 in FIG. 7. As seen in FIG. 8, since the turn-on order of the gate lines G1˜G10 is G1, G2, G5, G6, G9, G10, G7, G8, G3, G4, the source driver 1040 decreasingly outputs the driving voltages. Comparing to the prior arts, the example of the present invention reduces the frequency of outputting positive and negative voltages alternately or avoid adjacently outputted driving voltages varying too greatly, thus reduces power consumption, and increases system performance.

Therefore, each time the frame changes, the cache device 1021 caches data of sub-pixels of a frame. Next, the calculation unit 1022 arranges a turn-on order of the gate lines G1˜Gn according to the restored data of the sub-pixels of the frame, such that adjacently turned-on TFTs have sub-pixels of the same polarity or have minimum driving voltage differences. Consequently, the example of the present invention prevents a source driver from alternately outputting positive and negative voltages frequently or avoids adjacently outputted driving voltages varying too greatly, and achieves power conservation.

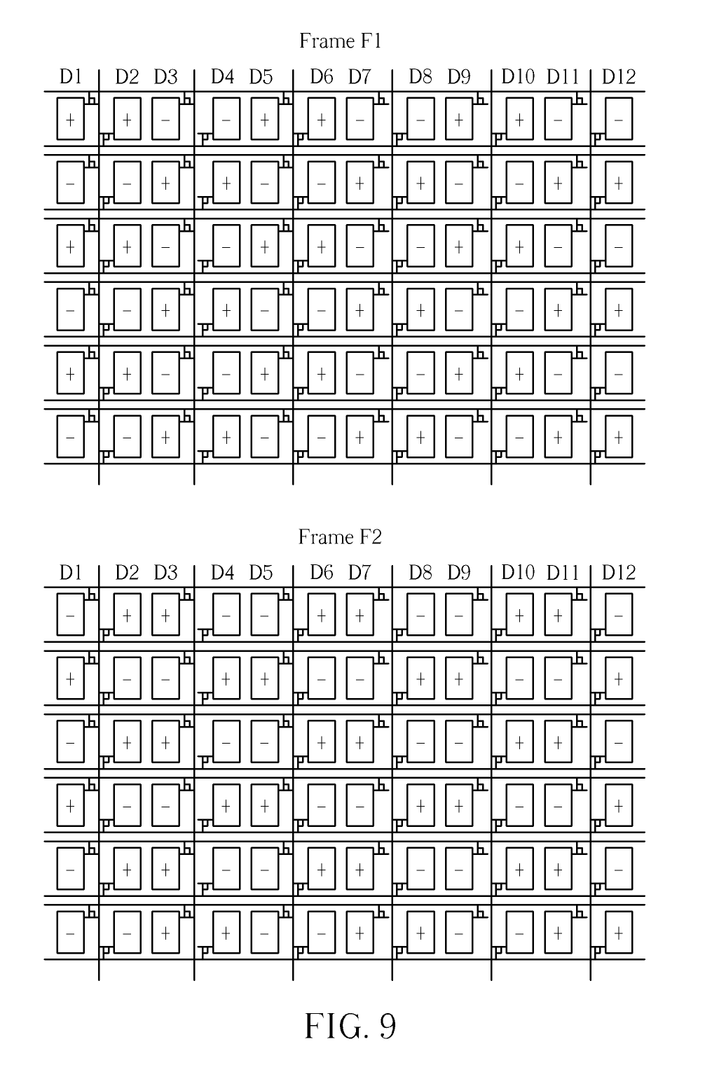

On the other hand, when the frame F1 changes to the frame F2, the polarities of whole data lines are the same for a moment. If a common voltage Vcom shifts, under the same grayscale configuration, magnitude of the positive voltage differs from magnitude of the negative, which generates flickers. In order to avoid problems caused by uneven-luminance lines when the frame F1 changes to the frame F2, the embodiment of the present invention uses a first polarity inversion driving method to drive sub-pixels P11˜Pmn of the F1 frame in the frame F1, and uses a second polarity inversion driving method to drive sub-pixels P11˜Pmn of the frame F2 in the frame F2. Preferably, the first polarity inversion driving method could be a two-line-dot inversion, and the second polarity inversion driving method could be a two-line+1 inversion. In other words, the example of the present invention reduces the number of data lines having the same polarity by employing different polarity inversion driving methods. Please refer to FIG. 9, which is a schematic diagram of the frame F1 and the frame F2 according to an example of the present invention. Among which, the frame F1 adopts the two-line-dot inversion driving method, while the frame F2 adopts the two-line+1 inversion driving method. As seen in FIG. 9, when the frame F1 changes to the frame F2, polarities of data lines D2, D4, D6, D8, D10 and D12 remain the same, thereby reducing the number of data lines which have the same polarity when the frame changes, and further improving the problems caused by the uneven-luminance lines.

In addition, in order to avoid problems caused by the same polarity on a whole data line when the frame changes, the gate driver 1060 turns on the TFTs, e.g. T11˜Tln, on each of the data lines, e.g. data line D1, by segments. For example, In the table 1100, the turn-on order of the gate lines G1˜G10 is G1, G2, G5, G6, G9, G10, G7, G8, G3, G4, and thus the polarities of the sub-pixels on the data line D1 are arranged orderly +, +, +, +, +, +, −, −, −, −. If the gate driver 1060 turns on the TFTs of the data line D1 by segments, the turn-on order of the gate lines G1˜G10 becomes G1, G2, G5, G3, G4, G6, G9, G10, G7, G8, and the polarities of the sub-pixels on the data line D1 are arranged orderly +, +, +, −, −, +, +, +, −, −. Consequently, the present invention diminishes the problems caused by the same polarities on the whole data line by starting the above mentioned mechanism by segments.

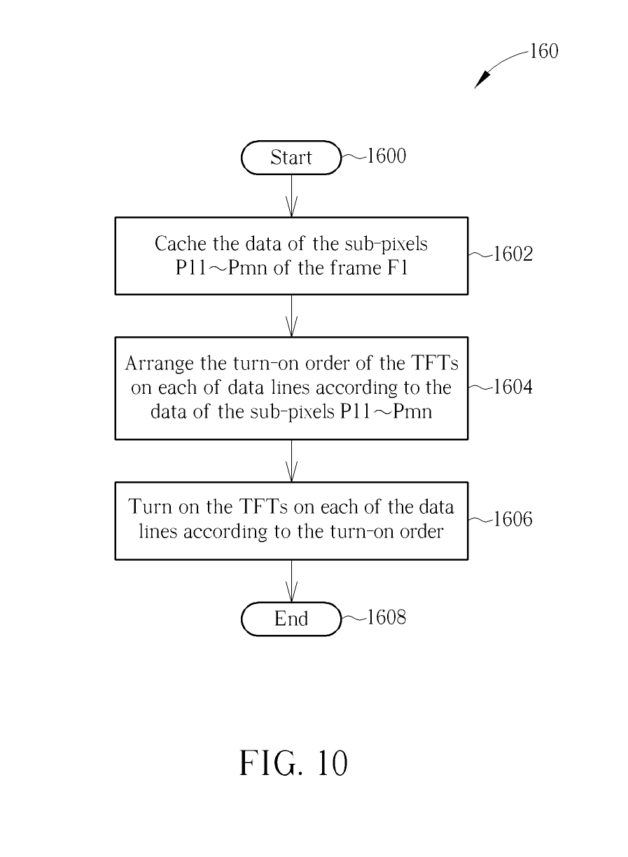

As shown in FIG. 10, operations related to the above mentioned the LCD device 1000 can be summarized into a process 160. The process 160 includes following steps:

Steps 1600: Start.

Steps 1602: Cache the data of the sub-pixels P11˜Pmn of the frame F1.

Steps 1604: Arrange the turn-on order of the TFTs on each of data lines according to the data of the sub-pixels P11˜Pmn.

Steps 1606: Turn on the TFTs on each of the data lines according to the turn-on order.

Steps 1608: End.

The process 160 is operations of the LCD device 1000, specifications or modifications can be referred in previous contents, and not detailed here.

To sum up, the present invention caches data of sub-pixels of a frame each time the frame changes, and arranges a turn-on order of gate lines G1˜G10 according to the restored data of the sub-pixels of the frame, such that adjacently turned-on TFTs have sub-pixels of the same polarity or have minimum driving voltage differences. Consequently, the present invention prevents a source driver from alternately outputting positive and negative voltages frequently or avoids adjacently outputted driving voltages varying too greatly, and achieves power conservation. Furthermore, the present invention uses different polarity inversion driving methods in different frames or turns on TFTs on each of data lines by segments to diminish problems caused by uneven-luminance lines when the frame changes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a liquid crystal display (LCD) device having a plurality of data lines and a plurality of thin film transistors (TFTs), the driving method comprising:
restoring data of a plurality of sub-pixels of a first frame, wherein the sub-pixels corresponds to the plurality of TFTs;
arranging a turn-on order of the plurality of TFTs on each of a plurality of gate lines according to the data of the plurality of sub-pixels; and
turning on the plurality of TFTs on each of the plurality of gate lines according to the turn-on order.

2. The driving method of claim 1, wherein the data of the plurality of sub-pixels comprise driving voltages of the plurality of sub-pixels.

3. The driving method of claim 2, wherein the step of arranging the turn-on order of the plurality of TFTs on each of the plurality of data lines according to the data of the plurality of sub-pixels comprises:
arranging the turn-on order of each of the plurality gate lines when the data of the plurality of sub-pixels are driving voltages of the plurality of sub-pixels, such that corresponding sub-pixels of two adjacent TFTs in the turn-on order have a minimum driving voltage difference.

4. The driving method of claim 3, wherein turning on the plurality of TFTs on the each of the plurality of gate lines according to the turn-on order comprises:
decreasingly outputting the driving voltages of the plurality of sub-pixels.

5. The driving method of claim 3, wherein turning on the plurality of TFTs on the each of the plurality of gate lines according to the turn-on order comprises:
increasingly outputting the driving voltages of the plurality of sub-pixels.

6. The driving method of claim 1, further comprising:
using a first polarity inversion method to drive the plurality of sub-pixels of the first frame when in the first frame, and when in a second frame, using a second polarity inversion method to drive the plurality of sub-pixels of the second frame.

7. The method of claim 6, wherein the first polarity inversion method is a two-line-dot inversion, and the second polarity inversion method is a two-line+1 inversion.

8. The driving method of claim 1, further comprising:
turning on the plurality of TFTs on each of the plurality of gate lines by segments.

9. A liquid crystal display (LCD) device, comprising:
a panel, having a plurality of data lines and a plurality of thin film transistors (TFTs), wherein the plurality of TFTs corresponds to a plurality of sub-pixels of a first frame;
a backlight module, for providing backlights to the panel; and
a timing control device, comprising:
a frame buffer, for restoring data of the plurality of sub-pixels of the first frame;
a calculation unit, for arranging a turn-on order of the plurality of TFTs on each of the plurality of gate lines according to the data of the plurality of sub-pixels; and
a gate driver, for turning on the plurality of TFTs on each of the plurality of gate lines according to the turn-on order.

10. The LCD device of claim 8, wherein the data of the plurality of sub-pixels comprise driving voltages of the sub-pixels.

11. The LCD device of claim 10, wherein the calculation unit arranges the turn-on order on each of the plurality of gate lines when the data of the plurality of sub-pixels are the driving voltages of the plurality of sub-pixels, such that corresponding sub-pixels of two adjacent TFTs in the turn-on order have a minimum driving voltage difference.

12. The LCD device of claim 11, wherein the gate driver decreasingly outputs the driving voltages of the plurality of sub-pixels.

13. The LCD device of claim 11, wherein the gate driver increasingly outputs the driving voltages of the plurality of sub-pixels.

14. The LCD device of claim 9, further comprising a source driver, for using a first polarity inversion method to drive the plurality of sub-pixels of the first frame when in the first frame, and when in a second frame, using a second polarity inversion method to drive the plurality of sub-pixels of the second frame.

15. The LCD device of claim 14, wherein the first polarity inversion method is a two-line-dot inversion, and the second polarity inversion method is a two-line+1 inversion.

16. The LCD device of claim 9, wherein the gate driver is further utilized for turning on the plurality of TFTs on each of the plurality of gate lines by segments.

17. The LCD device of claim 9, wherein the number of the plurality of sub-pixels restored by the frame buffer is ¼ of the number of the plurality of sub-pixels of the first frame or a multiple of the number of the plurality of sub-pixels of the first frame.

18. The driving method of claim 2, wherein each of the plurality of data lines is electrically connected to pixels in two adjacent columns.

19. The LCD device of claim 9, wherein each of the plurality of data lines is electrically connected to pixels in two adjacent columns.
